(19) United States
(12) Patent Application Publication
(10) Pub. No.: US 2026/0120260 A1
(43) Pub. Date: Apr. 30, 2026

(54) Correction and Harmonization of Devices

(71) Applicant: The Government of the United States of America, as represented by the Secretary of the Navy, Arlington, VA (US)

(72) Inventors: Dagmar Leary, Washington, DC (US); William Hervey, Washington, DC (US); Samuel Blisard, Washington, DC (US); Adam Knapp, Washington, DC (US); Kristen Jacobson, Washington, DC (US); Jaimee Compton, Washington, DC (US)

(73) Assignee: The Government of the United States of America, as represented by the Secretary of the Navy, Arlington, VA (US)

(21) Appl. No.: 18/902,620

(22) Filed: Sep. 30, 2024

Related U.S. Application Data
(63) Continuation of application No. 18/901,940, filed on Sep. 30, 2024.

(51) Int. Cl. G06T 7/00; G06T 11/10; G06V 10/764; G06V 10/82; G06V 10/98; G06V 20/70

(52) U.S. Cl. CPC G06T 7/0002; G06T 11/10; G06V 10/764; G06V 10/82; G06V 10/993; G06V 20/70; G06T 2207/20084; G06T 2207/30168; G06T 2210/32; G06V 2201/10

(57) ABSTRACT

Systems and methods are provided for correction and harmonization of data from multiple devices, such as scientific instruments. Embodiments of the present disclosure provide systems and methods to automate this process to increase data throughput while standardizing that data despite differences in instrument settings and the challenges of proprietary software. For example, embodiments of the present disclosure include a functioning workflow for acquiring and digesting in very large datasets generated by scientific instruments for the oceanic microbiome proteome which can harmonize data taken from instruments of multiple make, model, and settings and detect flawed data/malfunctioning instruments.

### CROSS REFERENCE TO RELATED APPLICATIONS

This application is a continuation of U.S. patent application Ser. No. 18/901,940, filed on Sep. 30, 2024, which is incorporated by reference herein in its entirety.

### FEDERALLY SPONSORED RESEARCH AND DEVELOPMENT

The United States Government has ownership rights in this invention. Licensing inquiries may be directed to Office of Technology Transfer at US Naval Research Laboratory, Code 1004, Washington, DC 20375, USA; +1.202.767.7230; techtran@nrl.navy.mil, referencing Navy Case Number 210160-US4.

### FIELD OF THE DISCLOSURE

This disclosure relates to error detection, including device interoperability.

### BACKGROUND

Many organizations, such as the U.S. government, have vast technical data stores. Unfortunately, that same data is often locked in and/or generated by unstandardized and/or proprietary formats. There is a real and persistent need to change this situation in order to speed application of technical data this is otherwise “locked away” and to correct for idiosyncrasies and aberrations in its collection. The acquisition and processing of large quantities of data from multiple different devices (e.g., from different scientific instruments) presents considerable challenges for analysis by a human expert. Not only is this data voluminous, but frequently it is taken by a variety of instruments of differing make, model, and software type, often subject to idiosyncrasies of local settings and specific manufacture. Typically a human expert is called upon to clean and harmonize this data. Cleaning and harmonizing this data requires a large amount of time and is subject to human error.

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1A is a diagram of an exemplary system for harmonizing devices in accordance with an embodiment of the present disclosure;

FIG. 1B is another diagram of an exemplary system for harmonizing devices in accordance with an embodiment of the present disclosure;

FIG. 2 is a flowchart for an exemplary method for harmonizing devices in accordance with an embodiment of the present disclosure;

FIG. 3 is a diagram of an exemplary system for harmonizing mass spectrometry devices in accordance with an embodiment of the present disclosure;

FIG. 4 is a flowchart for an exemplary method for harmonizing mass spectrometry devices in accordance with an embodiment of the present disclosure;

FIG. 5A shows a series of images generated from a dataset used to detect the presence of Amyotrophic Lateral Sclerosis (ALS) in accordance with an embodiment of the present disclosure;

FIG. 5B shows a larger series of images generated from the dataset used to detect the presence of ALS in accordance with an embodiment of the present disclosure;

FIG. 6 is a flowchart of an exemplary method for data harmonization in accordance with an embodiment of the present disclosure; and

FIG. 7 is a flowchart of exemplary method for image creation in accordance with an embodiment of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to understand that such description(s) can affect such feature, structure, or characteristic in connection with other embodiments whether or not explicitly described.

### 1. OVERVIEW

Embodiments of the present disclosure provide systems and methods for correction and harmonization of data from multiple devices, such as scientific instruments. Embodiments of the present disclosure provide systems and methods to automate this process to increase data throughput while standardizing that data despite differences in instrument settings and the challenges of proprietary software.

For example, embodiments of the present disclosure include a functioning workflow for acquiring and digesting in very large datasets generated by scientific instruments for the oceanic microbiome proteome which can harmonize data taken from instruments of multiple make, model, and settings and detect flawed data/malfunctioning instruments.

Embodiments of the present disclosure enable the automated standardization of data collected by multiple analytical instruments. Embodiments of the present disclosure decrease costs by lessening dependence on skilled labor, enabling faster workflows while harmonizing complex data to a standard which enables subsequent analyses which means that that data can then be analyzed by anyone who knows the standard and not the specifics of the data's original collection.

### 2. EXEMPLARY SYSTEMS AND METHODS FOR HARMONIZING DEVICES

Using liquid chromatography-mass spectrometry (LC-MS/MS) as a test case, embodiments of the present disclosure provide systems and methods to correct and standardize the proteomic/bioinformatic data generated by multiple LC-MS/MS systems that differ by make, model, and the specifics of manufacture while being further complicated by proprietary and often closed data formats. In an embodiment, the data generated by these systems is first collected and digitally converted into standardized formats when possible for some LC-MS/MS systems. For other systems, computer automated graphical user interface (GUI) operations generated either by specialized software or by deep learning can be used to extract data from human-oriented, instrument software interfaces and convert it into those same standardized formats.

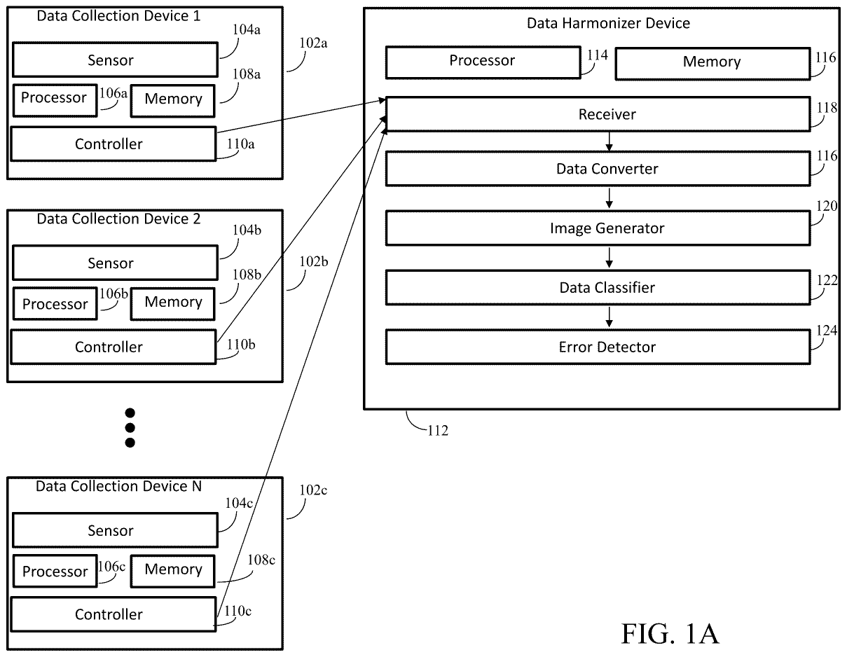

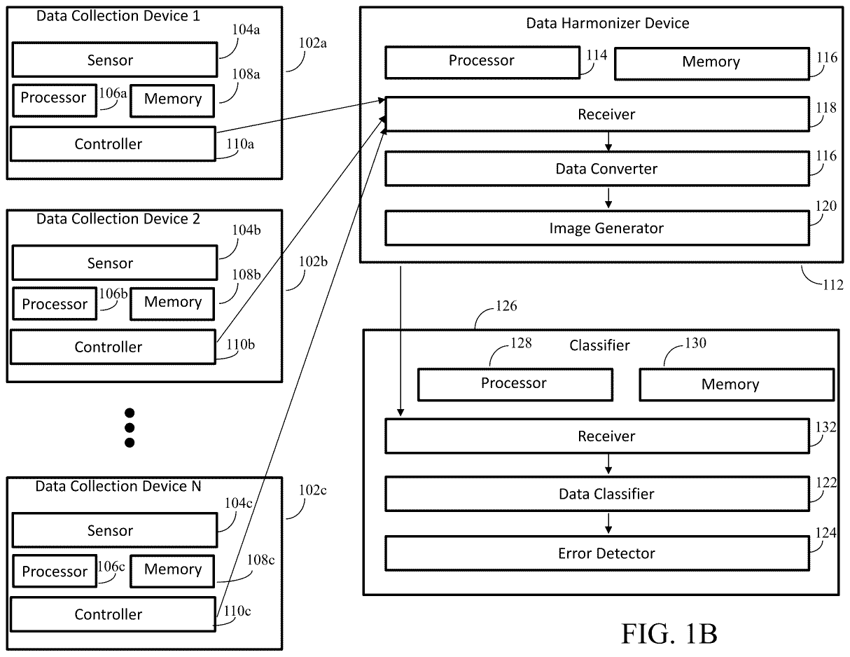

FIG. 1A is a diagram of an exemplary system for harmonizing devices in accordance with an embodiment of the present disclosure. In FIG. 1A, a plurality of data collection devices 102 are used to collect data, and this data can be sent to a data harmonizer device 112 for harmonization. FIG. 1A shows three data collection devices 102a, 102b, and 102c; however, it should be understood that any number of data collection devices 102 can be used in accordance with embodiments of the present disclosure. In FIG. 1A, each data collection device 102 includes a sensor 104, a processor 106, a memory 108, and a controller 110. In FIG. 1A, data harmonizer device 112 includes a processor 114, a memory 116, a receiver 118, a data converter 116, an image generator 120, a data classifier 122, and an error detector 124.

In an embodiment, data collection devices 102 collect data (e.g., using sensors 104) and optimally store the data in memories 108. In an embodiment, this data is collected by data harmonizer device 112. For example, in an embodiment, data collection devices 102 send the data to data harmonizer device 112 using controllers 110 (e.g., after measuring and/or collecting the data). In an embodiment, data harmonizer device 112 requests the data from data collection devices 102. In an embodiment, receiver 118 of data harmonizer device 112 receives the data for harmonization from data collection devices 102.

In an embodiment, controllers 110 of data collection devices 102 are configured (e.g., with software and/or hardware) to wait for data to be collected (e.g., after an experiment is complete) and can then copy corresponding data files to memories 108. In an embodiment, controllers 110 of data collection devices 102 can be configured to automatically send data to data harmonizer device 112. In an embodiment, controllers 110 of data collection devices 102 can be configured to prompt a user to send data to data harmonizer device 112. In an embodiment, data harmonizer device 112 can send a signal to corresponding data collection devices 102 to prompt a user to send data to data harmonizer device 112.

In an embodiment, data converter 116 converts the data from data from data collection devices 102 into a unified format. For example, in an embodiment, data converter 116 can parse the data for metadata and calibration parameters, aggregate the data, and use vendor independent libraries (e.g., stored in memory 116) to extract metadata from respective vendor encoded formats from the experimental data. In an embodiment, these vendor independent libraries can be used to convert the experimental data from respective vendor formats into a unified markup format.

In an embodiment, image generator 120 generates an image based on this converted data (e.g., a heat map image). In an embodiment, data classifier 122 classifies the generated image as belonging to a label. For example, in an embodiment, data from a corresponding data collection device can have metadata that identifies the data as representing a specific label. For example, the data can correspond to a specific organism, to a person with Amyotrophic Lateral Sclerosis (ALS), or to mass spectrometry data including chromatographic retention time (T1), mass to charge ratio, and peak intensity. In an embodiment, image generator 120 can generate an image (e.g., by graphing retention time by molecular weight and intensity based on the data), and classifier 122 can classify the image based on the metadata so the image can be identified as belonging to a specific label (e.g., to a specific organism, to a person with ALS, or to mass spectrometry data).

In an embodiment, error detector 124 detects errors in the classified image. For example, in an embodiment, error detector 334 can determine outliers in the classified image. In an embodiment, the image can be sent to a deep learning network, such as a convolutional neural network (CNN), which can analyze spatial relationships in the image. In an embodiment, the CNN can train its internal weights to be able to classify further images as one of a plurality of predefined labels based on the label and data inside the image.

In an embodiment, these detected errors can be traced to corresponding data collection devices 102. In an embodiment, data harmonizer device 112 can remove these errors from the collected data (e.g., by removing outliers), optimally send a signal to the corresponding data collection device to remediate the error (e.g., by sending a signal to the corresponding controller of the device that caused the error), and/or store information (e.g., in memory 116) indicating the errors so that information from the data collection device can be flagged in the future.

FIG. 1B is another diagram of an exemplary system for harmonizing devices in accordance with an embodiment of the present disclosure. In FIG. 1B, classifier 126 is shown as a separate device from data harmonizer device 112. In FIG. 1B, classifier 126 includes a processor 128, a memory 130, a receiver 132, data classifier 122, and error detector 124. Data harmonizer device 122 and classifier 126 can be implemented using hardware, software, and/or a combination of hardware and software in accordance with embodiments of the present disclosure. Data harmonizer device 122 and classifier 126 can be implemented using a single device or multiple devices in accordance with embodiments of the present disclosure. Data harmonizer device 122 and classifier 126 can be implemented as special purpose device(s) or can be integrated into a host device in accordance with embodiments of the present disclosure.

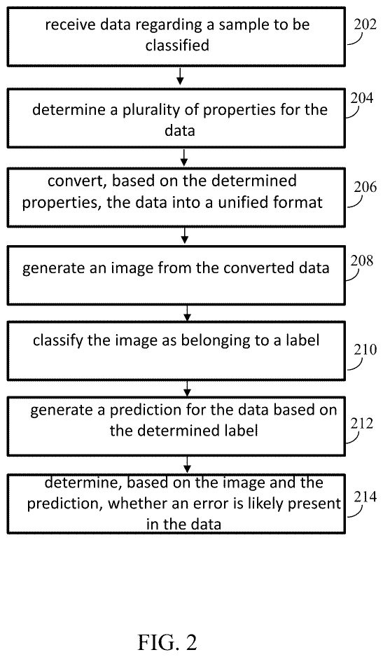

FIG. 2 is a flowchart for an exemplary method for harmonizing devices in accordance with an embodiment of the present disclosure. In step 202, data regarding a sample to be classified is received. For example, in an embodiment, receiver 118 receives data from data collection devices 102. In step 204, a plurality of properties for the data are determined. For example, in an embodiment, data converter 116 can parse the data for properties such as metadata and calibration parameters. In step 206, the data is converted, based on the determined properties, into a unified format. For example, in an embodiment, data converter 116 can convert the data into a unified format based on the determined properties. In step 208, an image is generated from the converted data. For example, in an embodiment, image generator 120 can generate an image, such as a heat map, from the converted data. In an embodiment, a feature map is determined based on the image. For example, in an embodiment, data classifier 122 can determine a feature map based on the image. In step 210, the image is classified as belonging to a label. For example, in an embodiment, data classifier 122 can classify the image as belonging to a specific label.

In step 212, a prediction for the data is generated based on the determined label. For example, in an embodiment, error detector 124 can examine stored information with the same label (e.g., based on prior collected data and analysis) to predict how the image should look. In step 214, a determination is made, based on the image and the prediction, whether an error is likely present in the data. For example, in an embodiment, error detector 124 can determine data points in the image that don't correspond to the prediction (e.g., by determining outliers in the image) and can identify these data points as likely errors.

### 2. EXEMPLARY SYSTEMS AND METHODS FOR HARMONIZING MASS SPECTROMETRY DEVICES

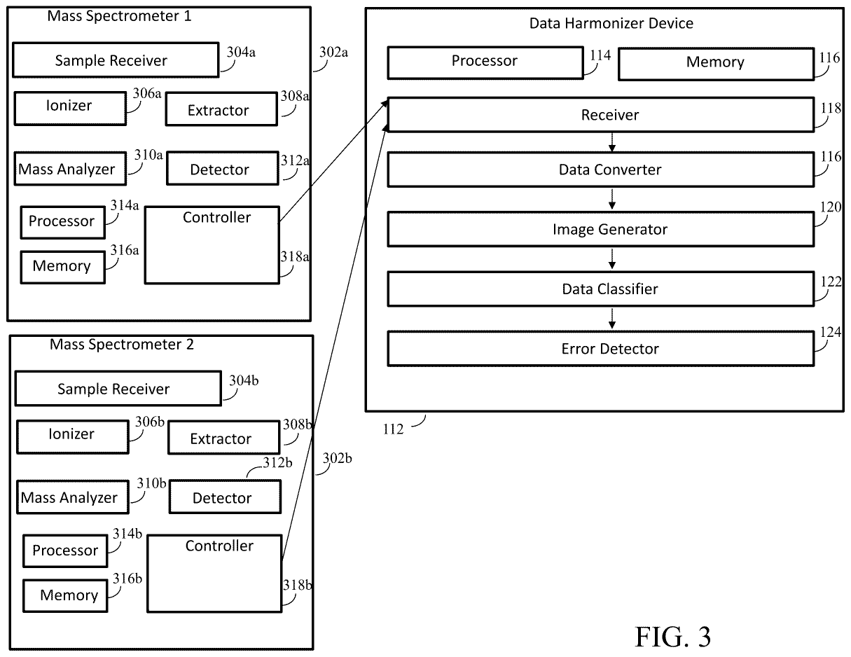

FIG. 3 is a diagram of an exemplary system for harmonizing mass spectrometry devices in accordance with an embodiment of the present disclosure. FIG. 3 shows two mass spectrometers 302. However, it should be understood that any number of mass spectrometers 302 can be used in accordance with embodiments of the present disclosure. In FIG. 3, each mass spectrometer includes a sample receiver 304, an ionizer 306, an extractor 308, a mass analyzer 310, a detector 312, a processor 314, a memory 316, and a controller 318. The components of mass spectrometers 302 shown in FIG. 3 are provided by way of example and are not limiting. It should be understood that varying types of mass spectrometers can be used in accordance with embodiments of the present disclosure, and individual mass spectrometers can have different and/or additional components. In an embodiment, data from mass spectrometers 302 can be sent to data harmonizer device 112 for harmonization and processing.

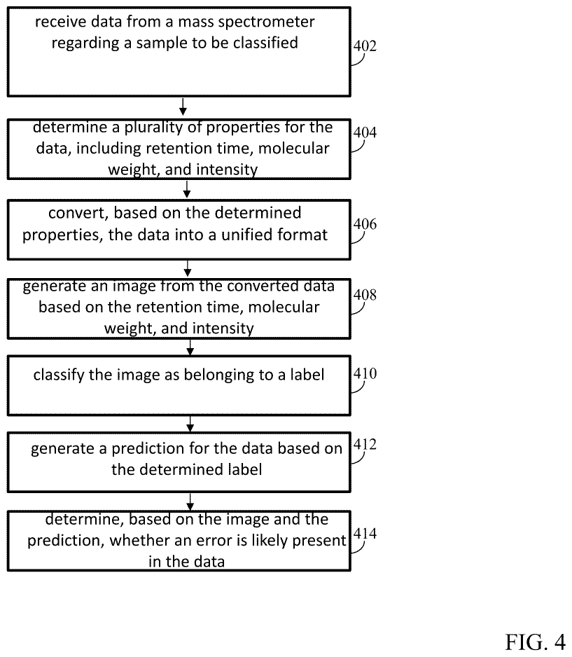

FIG. 4 is a flowchart for an exemplary method for harmonizing mass spectrometry devices in accordance with an embodiment of the present disclosure. In step 402, data is received from a mass spectrometer regarding a sample to be classified. For example, in an embodiment receiver 118 receives data from data mass spectrometers 302. In step 404, a plurality of properties for the data are determined including retention time, molecular weight, and intensity. For example, in an embodiment, data converter 116 can parse the data for properties such as retention time, molecular weight, and intensity as well as metadata indicating that the data is mass spectrometry data. In step 406, the data is converted, based on the determined properties, into a unified format. For example, in an embodiment, data converter 116 can convert the data into a unified format based on the determined properties (e.g., based on retention time, molecular weight, and intensity).

In an embodiment, experimentally relevant metadata can be added to the data (e.g., by data converter 116) including a random unique identifier (UUID) and project specific labels (e.g., an organism type) to the data. For example, in some cases, this information may not be present in metadata from a specific data collection device 102 and/or a mass spectrometer 302 but can be known to data converter 116 (e.g., based on metadata in other devices or based on user input). This added experimentally relevant metadata can be used to generate labels and/or use the data for correcting errors in similar data processed at a later date. In an embodiment, data converter 116 can use the UUIDs from data from different data collection devices 102 and/or mass spectrometers 302 to convert the data into a unified format. In an embodiment, the converted data can be transferred to a memory for storage (e.g., memory 116). In an embodiment, data converter 116 can use vendor libraries to take vendor proprietary data and convert it to a format usable by a CNN.

In step 408, an image is generated from the converted data based on the determined properties. For example, in an embodiment, image generator 120 can generate an image, from the converted mass spectrometry data. In step 410, the image is classified as belonging to a label. For example, in an embodiment, data classifier 122 can classify the image as belonging to mass spectrometry data and/or a specific kind of mass spectrometry data based on metadata.

In step 412, a prediction for the data is generated based on the determined label. For example, in an embodiment, error detector 124 can examine stored mass spectrometry data and/or corresponding generated images same label (e.g., mass spectrometry data and/or a specific kind of mass spectrometry data) to predict how the image should look. In step 414, a determination is made, based on the image and the prediction, whether an error is likely present in the data. For example, in an embodiment, error detector 124 can determine data points in the image that don't correspond to the prediction (e.g., by determining outliers in the image) and can identify these data points as likely errors. In an embodiment, this determination can be used to identify and adjust a mass spectrometer corresponding to the erroneous data.

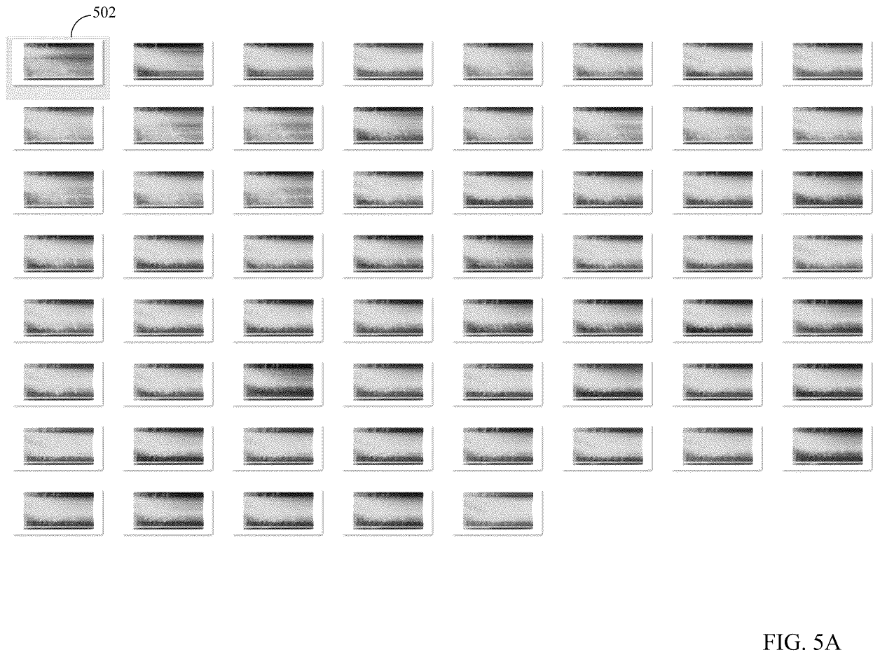

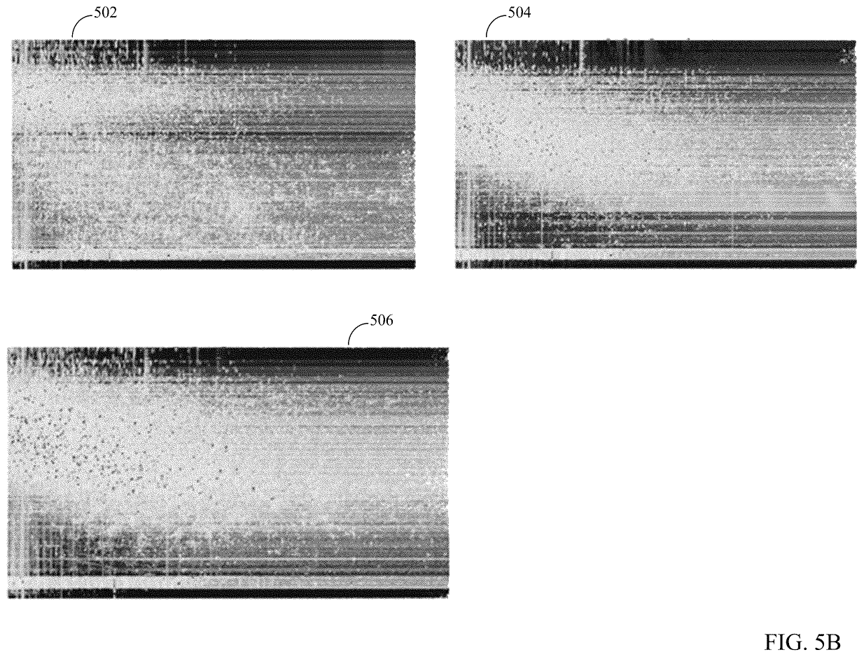

FIG. 5A shows a series of images generated from a dataset used to detect the presence of Amyotrophic Lateral Sclerosis (ALS) in accordance with an embodiment of the present disclosure. As shown in FIG. 5A, the first image 502 is significantly visually distinct from other images and can be identified as containing an error (e.g., by error detector 124. FIG. 5A shows larger versions of images form the images shown in FIG. 5A. In FIG. 5A, the first image 502 contains an error, the second image 504 is from a healthy patient, and the third image 506 is from a patient with ALS.

FIG. 5B shows a larger series of images generated from the dataset used to detect the presence of ALS in accordance with an embodiment of the present disclosure. As shown in FIG. 5B, the first image 502 is significantly visually distinct from both the healthy and ALS sample and can be identified to be removed from the dataset without removing images from patients with ALS, such as the third image 506. In an embodiment, datasets from healthy patients and patients with ALS can be used to train error detector 124 to avoid accidental removal of valid data.

### 3. EXEMPLARY HARMONIZATION

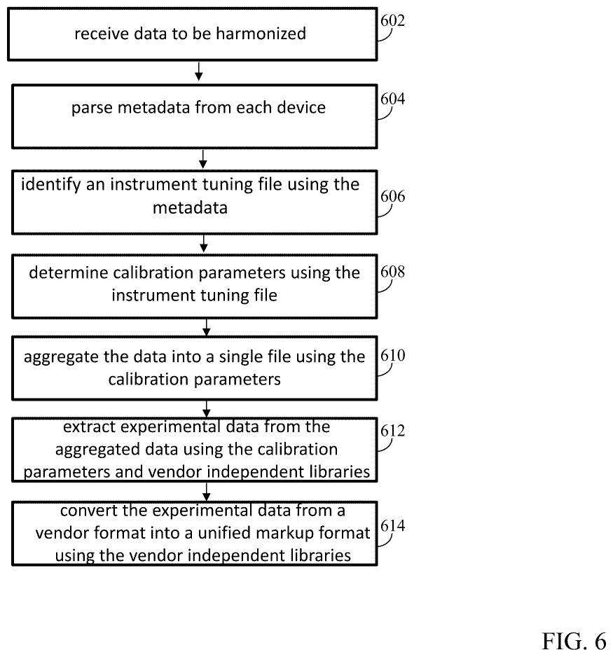

FIG. 6 is a flowchart of an exemplary method for data harmonization in accordance with an embodiment of the present disclosure. In step 602, data to be harmonized is received. For example, in an embodiment, data harmonizer device 112 receives data from data collection devices 102. In step 604, metadata from each device is parsed (e.g., by data converter 116). In step 606, an instrument tuning file is identified using the metadata. For example, in an embodiment, data converter 116 parses metadata from each device, and the metadata shows which analytical method was used by the instrument. For example, in an embodiment, for a liquid chromatography system that has its own computer, the metadata would have a pointer to a location in memory of the computer that controls the instrument, and this memory has experimental parameters that the data were acquired under. In an embodiment, using this metadata, an instrument tuning file on that same computer can be located. In an embodiment, this instrument tuning file can be sent from respective data collection devices 102 to data harmonizer device 112. In an embodiment, data harmonizer device 112 can request this instrument tuning file from respective data collection devices 102.

In step 608, calibration parameters are determined (e.g., by data converter 116) using the instrument tuning file. For example, in an embodiment, the instrument tuning file has calibration parameters (e.g., for environmental conditions), and these calibration parameters provide metric(s) for the accuracy of the measurement. In step 610, the data is aggregated into a single file using the calibration parameters. For example, in an embodiment, data converter 116 aggregates the data into a single file and lists the number and type of each device and corresponding calibration parameters. In an embodiment, calibration parameters include observed vs. experimental mass to charge, observe/theoretical retention time, mass, etc.

In step 612, experimental data is extracted from the aggregated data using the calibration parameters and vendor independent libraries. For example, in an embodiment, data converter 116 accesses vendor independent libraries (e.g., stored in memory 116) and extracts experimental data from the aggregated data in respective vendor encoded formats of data collection devices 102a using the calibration parameters and vendor independent libraries. In step 614, the experimental data is converted (e.g., by data converter 116) from a vendor format into a unified markup format using the vendor independent libraries. In an embodiment, the file in this unified markup format can be sent to image generator 120 for processing.

### 4. EXEMPLARY IMAGE CREATION

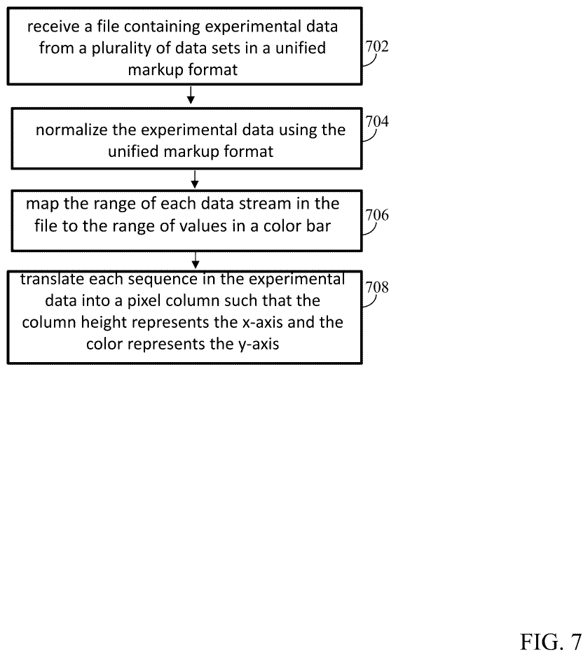

FIG. 7 is a flowchart of exemplary method for image creation in accordance with an embodiment of the present disclosure. In step 702, a file containing experimental data from a plurality of data sets in a unified markup format is received (e.g., by image generator 120). In step 704, the experimental data is normalized using the unified markup format. For example, in an embodiment, image generator 120 normalizes the data to remove anomalies. In an embodiment, the results of the normalization process are improved using the unified format (e.g., because the data has already been harmonized into a single format before it is normalized).

In step 706, the range of each data stream in the file is mapped to the range of values in a color bar (e.g., by image generator 120). In step 708, each sequence in the experimental data is translated (e.g., by image generator 120) into a pixel column such that the column height represents the x-axis and the color represents the y-axis. In an embodiment, each image has specific regions that represent different kinds of data. Because similar types of data are co-located, the usage of traditional image analysis and feature extraction techniques is enabled.

In an embodiment, the method of FIG. 7 can be used to convert a wide variety of types of data into images for easier error detection and processing. For example, in an embodiment, observed mass to charge ratio and corresponding retention time can be used to generate heat maps. In another embodiment, data used to detect ALS in a patient can be converted into respective heat maps, as shown, for example, by FIGS. 5A and 5B. In an embodiment, the image generated from the method of FIG. 7 can be sent to error detector 124 for error detection and processing.

### 5. EXEMPLARY MACHINE LEARNING

In an embodiment, error detector 124 receives the image from data classifier 122. In an embodiment, error detector 124 detects errors in the classified image. For example, in an embodiment, error detector 334 can determine outliers in the classified image. In an embodiment, error detector 124 can send the image to a deep learning network, such as a convolutional neural network (CNN), which can analyze spatial relationships in the image. In an embodiment, the CNN can train its internal weights to be able to classify further images as one of a plurality of predefined labels based on the label and data inside the image.

In an embodiment, error detector 124 reserves a portion of the data for testing to see if it properly classifies, (e.g. as healthy or diseased in the case of ALS data from FIGS. 5A and 5B). In an embodiment, N-fold cross validation can be done for training, and a subset of labeled data can be reserved for testing purposes (e.g. data that error detector 124 knows are properly labeled as healthy or diseased in an ALS example).

By extracting these features and creating feature maps, the data is easier and faster to handle and classify. In an embodiment, CNNs are used to identify protein specific features, such as those present in kanamycin-resistance gene (kanR), Lac repressor protein (LacL), red fluorescent protein (RFP), green fluorescent protein (GFP), and tetracycline repressor protein (TetR).

### 6. CONCLUSION

It is to be appreciated that the Detailed Description, and not the Abstract, is intended to be used to interpret the claims. The Abstract may set forth one or more but not all exemplary embodiments of the present disclosure as contemplated by the inventor(s), and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Any representative signal processing functions described herein can be implemented using computer processors, computer logic, application specific integrated circuits (ASIC), digital signal processors, etc., as will be understood by those skilled in the art based on the discussion given herein. Accordingly, any processor that performs the signal processing functions described herein is within the scope and spirit of the present disclosure.

The above systems and methods may be implemented using a computer program executing on a machine, using a computer program product, or using a tangible and/or non-transitory computer-readable medium having stored instructions. For example, the functions described herein could be embodied by computer program instructions that are executed by a computer processor or any one of the hardware devices listed above. The computer program instructions cause the processor to perform the signal processing functions described herein. The computer program instructions (e.g., software) can be stored in a tangible non-transitory computer usable medium, computer program medium, or any storage medium that can be accessed by a computer or processor. Such media include a memory device such as a RAM or ROM, or other type of computer storage medium such as a computer disk or CD ROM. Accordingly, any tangible non-transitory computer storage medium having computer program code that cause a processor to perform the signal processing functions described herein are within the scope and spirit of the present disclosure.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments.

What is claimed is:

1. A data harmonizer device, comprising:
a receiver configured to receive data from a plurality of data collection devices;
a data converter configured to convert the data into a unified markup format, thereby generating converted data;
an image generator configured to:
receive a file containing the converted data in the unified markup format,
normalize the converted data using the unified markup format,
map a range of each data stream in the file to a range of values in a color bar, and
translate each sequence in the converted data into a corresponding pixel column, thereby generating an image from the converted data;
a data classifier configured to generate a classification for the image, wherein the classification identifies the image as belonging to a label; and
an error detector configured to determine, based on the image and the classification, whether an error is likely present in the data.

2. The data harmonizer device of claim 1, wherein the image generator is further configured to:
translate each sequence in the converted data into the corresponding pixel column such that a column height in the corresponding pixel column represents an x-axis and a corresponding color in the color bar represents a y-axis.

3. The data harmonizer device of claim 1, wherein the image generator is further configured to:
generate the image such that the image includes regions corresponding to different types of data.

4. The data harmonizer device of claim 1, wherein the image generator is configured to:
generate the image such that similar types of data in the image are co-located.

5. The data harmonizer device of claim 1, wherein the image generator is further configured to:
generate a plurality of images corresponding to data from respective devices in the plurality of data collection devices.

6. The data harmonizer device of claim 1, wherein the image is a heat map.

7. The data harmonizer device of claim 1, wherein the error detector is further configured to:
receive the image; and
detect errors in the image.

8. The data harmonizer device of claim 7, wherein the error detector is further configured to:
determine whether outlier data is present in the image.

9. The data harmonizer device of claim 7, wherein the error detector is further configured to:
send the image to a convolutional neural network (CNN), wherein the CNN is configured to analyze spatial relationships in the image; and
detect errors in the image based on a determination from the CNN that errors are present in the image.

10. The data harmonizer of claim 7, wherein the data collection devices are mass spectrometry devices, and wherein the data is mass spectrometry data.

11. A data harmonizer device for harmonizing data received from a plurality of data collection devices, the data harmonizer device comprising:
a data converter configured to convert the data into a unified markup format, thereby generating converted data; and
an image generator configured to:
receive a file containing the converted data in the unified markup format,
normalize the converted data using the unified markup format,
map a range of each data stream in the file to a range of values in a color bar, and
translate each sequence in the converted data into a corresponding pixel column, thereby generating an image from the converted data.

12. The data harmonizer device of claim 11, wherein the image generator is further configured to translate each sequence in the converted data into the corresponding pixel column such that a column height in the corresponding pixel column represents an x-axis and a corresponding color in the color bar represents a y-axis.

13. The data harmonizer device of claim 11, wherein the image generator is further configured to generate the image such that the image includes regions corresponding to different types of data.

14. The data harmonizer device of claim 11, wherein the image generator is configured to generate the image such that similar types of data in the image are co-located.

15. The data harmonizer device of claim 11, wherein the image generator is further configured to generate a plurality of images corresponding to data from respective devices in the plurality of data collection devices.

16. A method for harmonizing data received from a plurality of data collection devices, the method comprising:
converting the data into a unified markup format, thereby generating converted data;
receiving a file containing the converted data in the unified markup format;
normalizing the converted data using the unified markup format;
mapping a range of each data stream in the file to a range of values in a color bar; and
translating each sequence in the converted data into a corresponding pixel column, thereby generating an image from the converted data.

17. The method of claim 16, further comprising:
generating a classification for the image, wherein the classification identifies the image as belonging to a label; and
determining, based on the image and the classification, whether an error is likely present in the data.

18. The method of claim 16, wherein translating each sequence in the converted data further comprises translating each sequence in the converted data into the corresponding pixel column such that a column height in the corresponding pixel column represents an x-axis and a corresponding color in the color bar represents a y-axis.

19. The method of claim 16, wherein similar types of data in the image are co-located.

20. The method of claim 16, further comprising:
generating a plurality of images corresponding to data from respective devices in the plurality of data collection devices.
